(19) United States
(12) Patent Application Publication
(10) Pub. No.: US 2019/0288537 A1
(43) Pub. Date: Sep. 19, 2019

(54) Intelligent Battery Management

(71) Applicant: Mobile Tech, Inc., Lake Oswego, OR (US)

(72) Inventor: Robert Logan Blaser, Farmington, UT (US)

(21) Appl. No.: 16/355,059

(22) Filed: Mar. 15, 2019

Related U.S. Application Data
(60) Provisional application No. 62/643,579, filed on Mar. 15, 2018.

(51) Int. Cl. H02J 7/00

(52) U.S. Cl. CPC H02J 7/0072; H04M 1/0202; H02J 7/0029

(57) ABSTRACT

Disclosed herein are a number of example embodiments for a circuit that can intelligently control a charging signal used for charging an on-board battery of an electronic device. The circuit can be included as part of a charger that can be used to charge the electronic device. In examples, the charger may be included as part of a product display assembly for presenting the electronic device to customers or as part of a docking system for the electronic device.

### CROSS-REFERENCE AND PRIORITY CLAIM TO RELATED PATENT APPLICATION

This patent application claims priority to U.S. provisional patent application Ser. No. 62/643,579, filed Mar. 15, 2018, and entitled “Intelligent Battery Management”, the entire disclosure of which is incorporated herein by reference.

### INTRODUCTION

It is believed that improvements are needed in the art with respect to battery management for electronic devices that have on-board re-chargeable batteries. For example, electronic devices such as tablet computers and mobile computing devices (such as smart phones) are typically designed with an expectation that their typical usage pattern will include a highly dynamic charge profile where their batteries are often and repeatedly discharged and re-charged. For example, a typical user of a smart phone may charge his or her phone overnight, and then only intermittently charge the phone during the day as needed; in which case the phone will experience a fairly dynamic charge profile where the battery experiences extended periods of both charging and discharging. Tablet computers are often used by people in a similar manner. The types of battery technology/battery chemistry used by most tablet computers and mobile computing devices tend to do best with such dynamic charge profiles.

However, many commercial uses of tablet computers and mobile computing devices have a tendency to leave such electronic devices plugged in and “charging” at all times (or at least for long extended periods). An example includes many commercial uses of tablet computers in docking systems such as kiosks or point-of-sale terminals at businesses. These types of commercial uses can lead to deteriorated battery health because of the extended periods of constant charging (where even a trickle charge will be applied to the battery when the battery is deemed fully charged). The commercial docking system scenario can further aggravate battery health because many such docking systems will also include a case enclosure for the docked tablet computer, and the presence of the case enclosure may increase the heat around the tablet computer. Further still, it is expected that the life cycle of a tablet computer in a docking system in a commercial setting will be a long duration (perhaps years). Because of these combinations of factors, it is believed that conventional battery charging practices with electronic devices such as tablet computers in many commercial settings may contribute to battery health problems such as battery swelling.

A conventional approach for managing battery health is often addressed by circuitry immediately alongside the battery itself. But, it believed that such conventional approaches do not adequately reduce problems arising from the extended charge durations for electronic devices that are experienced by electronic device batteries in many commercial settings. Furthermore, most external chargers for electronic devices are typically “dumb” chargers that do not themselves contribute to battery management.

In an effort to solve these problems in the art, disclosed herein are a number of solutions where the design of external chargers themselves provide capabilities for intelligent battery management to help reduce problems such as battery swelling.

For example, example embodiments are disclosed where a charger that is external from the electronic device is able to monitor an electrical characteristic of a charging signal that it provides to the electronic device for charging the electronic device's battery. As an example, the monitored electrical characteristic can be the current drawn by the electronic device from the charger. Based on this monitored electrical characteristic, the charger can estimate a state for the electronic device's battery and adjust its charging signal accordingly. As an example, the charger can reduce the charging signal if the monitored electrical characteristic exceeds a condition such as defined threshold. An example of such a reduction can be stopping the charging signal. The charging signal can later be increased in response to another defined condition being satisfied such as the expiration of a defined time period. An example of such an increase can be re-started the charging signal. The conditions used by the charger to govern these decisions and operations can be defined statically or dynamically, and they may optionally vary as a function of the type of electronic device being charged. Such a charger, where charging decisions are based on inferences about the battery's charge state as a function of electrical characteristics of the charging signal, can be characterized as selectively controlling the charging signal in an open loop mode.

As another example, additional example embodiments are disclosed where battery state is directly determined from the electronic device itself. For example, software executed by the electronic device can make charging decisions based on the determined battery state, and these charging decisions can be communicated to the charger through an interface. The charger that is external to the electronic device can then adjust its charging signal accordingly (e.g., turning the charging signal on or off based on charge command signals received from the electronic device). As another example, software executed by the electronic device communicates data representative of the determined battery state to the charger through an interface, and the decision-making intelligence about how the charging signal should be controlled is resident in the charger. This intelligence can make the charging decisions based on the battery characteristic data received from the electronic device itself. Such a charger where direct determinations of battery state are used to drive charging decisions can be characterized as selectively controlling the charging signal in a closed loop mode.

Furthermore, it should be understood that in other example embodiments, the charger can be capable of operating in both an open loop mode and a closed loop mode. For example, a charger can be configured to operate in the closed loop mode if the electronic device is capable of providing a charge command signal or battery characteristic data to it; and such a charger can also be configured to operate in the open loop mode if the electronic device is not capable of providing a charge command signal or battery characteristic data to it (either because the interface has failed for some reason or because the electronic device lacks the requisite battery management software).

These and other features and advantages of the present invention will be described hereinafter to those having ordinary skill in the art.

### BRIEF DESCRIPTION OF THE DRAWINGS

FIG. 1 depicts an example embodiment where a charger that is external to an electronic device is used to charge a battery on the electronic device.

FIG. 2A depicts an example process flow for intelligent battery management by an external charger.

FIG. 2B depicts another example process flow for intelligent battery management by an external charger.

FIG. 3 depicts an example charge profile for a battery of an electronic device with respect to a charging signal from an external charger.

FIG. 4A depicts an example embodiment of an external charger that can carry out the process flows of FIGS. 2A and/or 2B.

FIG. 4B depicts an example schematic for another example embodiment of example charger for carrying out the process flows of FIGS. 2A and/or 2B.

FIG. 5 depicts another example process flow for intelligent battery management by an external charger.

FIGS. 6A-C depict examples of different charge profiles for batteries of different electronic devices with respect to a charging signal from an external charger.

FIG. 6D depicts another example process flow for intelligent battery management by an external charger where different charge/discharge profiles of different types of electronic devices are taken into account.

FIG. 7A depicts another example process flow for intelligent battery management by an external charger where the charger is able to learn a charge profile for the electronic device.

FIG. 7B depicts an example process flow for determining a maximum current draw for a charging cycle.

FIG. 7C depicts another example process flow for intelligent battery management by an external charger where the charger is able to learn a charge profile for the electronic device.

FIG. 8A depicts, for an example closed loop embodiment where portions of intelligent battery management are carried out by both the electronic device and the external charger, an example process flow for intelligent battery management by the electronic device.

FIG. 8B depicts, for an example closed loop embodiment where portions of intelligent battery management are carried out by both the electronic device and the external charger, an example process flow for intelligent battery management by the external charger.

FIG. 9 depicts an example embodiment of an external charger and electronic device that can carry out the process flows of FIGS. 8A and 8B.

FIG. 10 depicts an example process flow for an example closed loop embodiment where portions of intelligent battery management are carried out by both the electronic device and the external charger.

FIG. 11A depicts, for another example closed loop embodiment where portions of intelligent battery management are carried out by both the electronic device and the external charger, an example process flow for intelligent battery management by the electronic device.

FIG. 11B depicts, for another example closed loop embodiment where portions of intelligent battery management are carried out by both the electronic device and the external charger, an example process flow for intelligent battery management by the external charger.

FIGS. 12A and 12B depict example docking systems in which intelligent battery management can be deployed.

FIGS. 13A and 13B depicts an example product display assembly in which intelligent battery management can be deployed.

### DETAILED DESCRIPTION OF EXAMPLE EMBODIMENTS

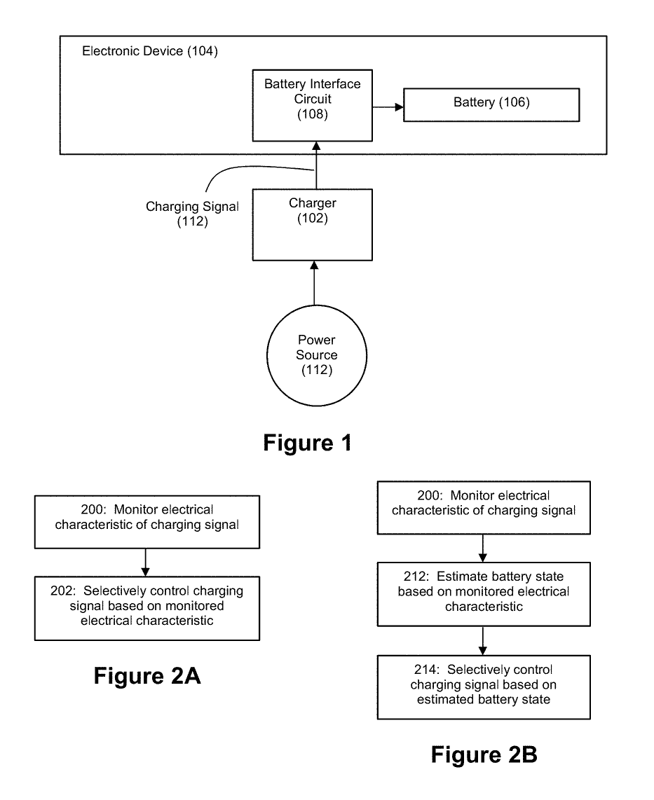

FIG. 1 depicts an example embodiment where a charger 102 that is external to an electronic device 104 is used to charge a battery 106 on the electronic device 104. As an example, the electronic device 104 can take the form of a tablet computer (e.g., a touchscreen tablet computer). However, the electronic device 104 could also take the form of other electronic devices, such as a mobile computing device (e.g., smart phone) or any other item of electronics having an on-board battery that can be re-charged via an external charger.

Upon connection of the charger 102 with the electronic device 104 (such as via a charging port of the electronic device), the charger 102 can provide a charging signal 112 to a battery interface circuit 108 in the electronic device 108. This battery interface circuit 108 can then charge the on-board battery 106 as is known in the art. The charger 102 can receive operational power from a power source 112. For example, the power source 112 can be power that is available from a typical wall outlet in a building. Accordingly, it should be understood that the power from a wall outlet may be further conditioned and/or regulated before it is received by the charger 102. For example, the AC voltage from a wall outlet may be converted to a DC voltage prior to the power reaching the charger 102.

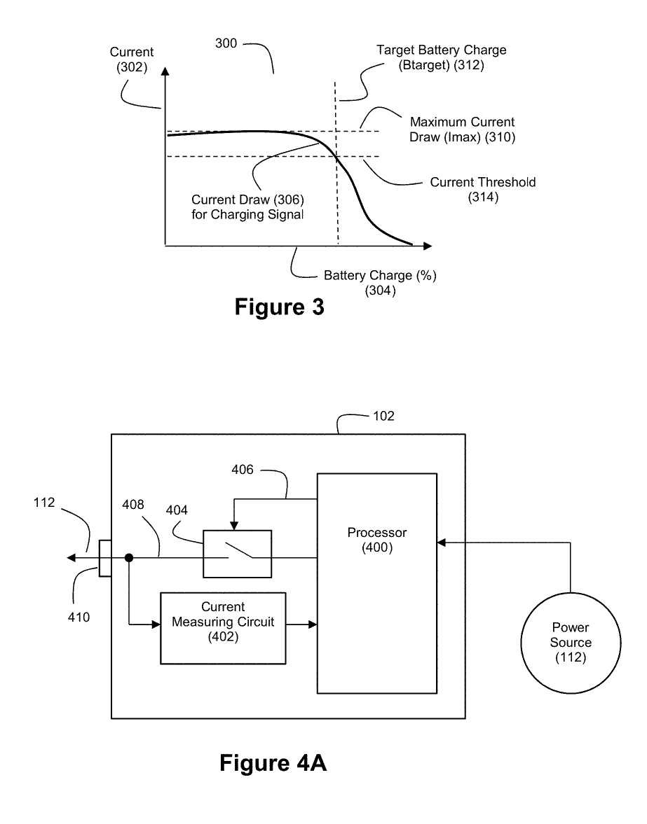

FIG. 2A depicts an example process flow for intelligent battery management by charger 102. At step 200, the charger 102 monitors an electrical characteristic of the charging signal 112. As an example, the monitored electrical characteristic can be the current of the charging signal 112. However, a practitioner may choose to leverage other electrical characteristics. For example, the monitored electrical characteristic may be voltage drops. Next, at step 202, the charger 102 selectively controls the charging signal based on the monitored electrical characteristic.

As an example, this selective control based on the monitored electrical characteristic can be a direct function of the value of the monitored electrical characteristic. For example, if the monitored electrical characteristic falls below a defined threshold, the charger 102 can reduce the charging signal 112 (e.g., reduce the current of charging signal 112 or stop the charging signal 112 altogether). However, it should be understood that the selective control at step 202 can be an indirect function of the value of the monitored electrical characteristic, as shown by the example of FIG. 2B. In the FIG. 2B example, the charger 102, estimates a state for the battery 106 based on the monitored electrical characteristic (step 212), and then selectively controls the charging signal 112 based on the estimated battery state (step 214).

The selective control steps 202/214 can also include the charger 102 increasing the charging signal 112 (which may include re-starting the charging signal 112 if the charging signal 112 had previously been stopped) if specified conditions are met (e.g., a defined time duration having passed).

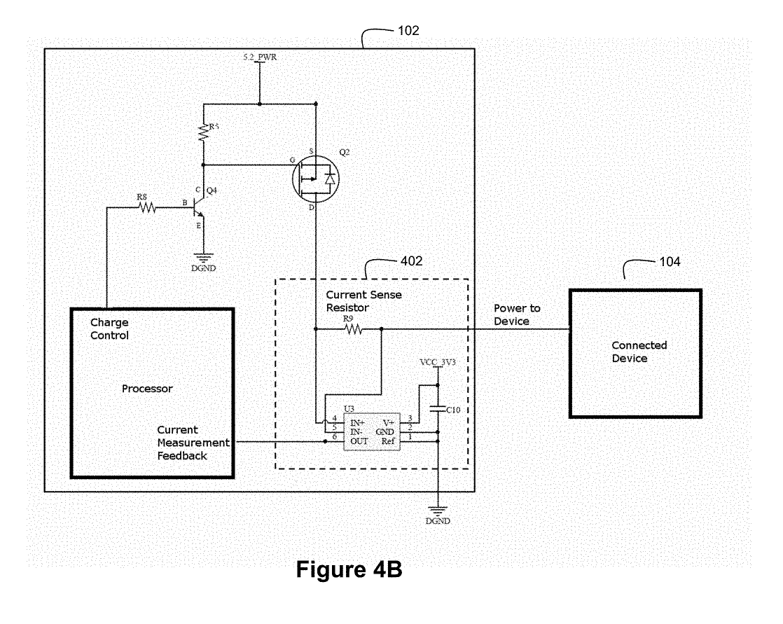

Many electronic devices 104 follow somewhat predictable curves when plugged into a charger, and charger 102 can leverage this predictability to estimate the level at which a battery is charged and make charging decisions accordingly. For example, when an electronic device 104 is plugged into the charger 102, the electronic device 104 will typically draw the max allowed current from the charger 102 while the battery 106 is charging (e.g., the battery's charge is at ˜80% or below). Once the charge state of the battery 106 starts to get above 80% of maximum charge, the electronic device 104 will typically begin to start drawing less current as the battery interface circuit 108 begins a slow/trickle charge cycle to top off the battery 106. FIG. 3 depicts an example charge profile 300 for battery 106 with respect to charging signal 112. The plot of FIG. 3 shows a current draw 306 exhibited by the charging signal 112 with respect to current amperage (vertical axis 302) versus battery charge percentage (horizontal axis 304). As noted, the maximum current draw (Imax) 310 is typically exhibited when the battery charge percentage is not full, and the current draw will decrease as the battery 106 becomes more fully charged. A practitioner can define a target battery charge (Btarget) 312 (e.g., 85%) at which the battery is likely not fully charged and at which the current draw is measurably below the maximum current draw. The current draw at Btarget can be used as a current threshold 314 by the charger 102 to make the decision about whether charging should be continued or reduced. The charger 102 can detect this transition from Imax 310 to the current threshold 314 to conclude that the battery 106 has reached Btarget 312, and the charger 102 can then remove the charging signal 112 for a time period (where this time period can be statically or dynamically defined based on a number of factors as explained below). After expiration of this time period, the charger 102 can then re-apply the charging signal 112 to the electronic device 104.

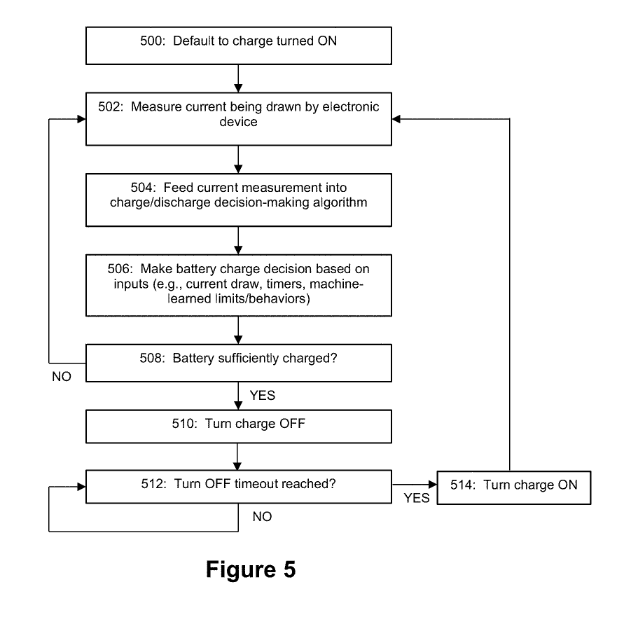

FIG. 4A depicts an example embodiment of the external charger 102 for use with the FIG. 2A/2B process flows. The charger 102 can include a processor 400 (which may take the form of a microcontroller or the like) that performs the decision-making about whether the charging signal 112 should be reduced/increased. The charger 102 can also include an interface 410 through which the charger 102 interfaces with electronic device 104. This interface 410 can provide a direct interface with the electronic device 104 (e.g., where the interface 410 can take the form of one or more contacts that are adapted to engage with complementary contacts of the electronic device 104) or interface 410 can provide an indirect interface with the electronic device 104 (e.g., where a connecting cable or other circuitry is in the path between interface 410 and the electronic device 104). As an example, the interface 410 may comprise a Universal Serial Bus (USB) connector, although it should be understood that other interfaces could readily be used by a practitioner.

The processor 400 can provide a voltage output (e.g., a 5V output, although other voltages could be employed) connected to power output 408, where power output 408 serves to provide charging signal 112 to the electronic device 104 via interface 410. The charger 102 can also include a switch 404 that is operable to connect or disconnect the voltage output from power output 408. Switch 404 can take the form of a FET switch or any other suitable switching technology that can selectively connect/disconnect power from power output 408. The processor 400 can include another output that provides a charge command signal 406 to switch 404. Thus, if the processor 400 decides that the charging signal 112 is to be stopped, the charge command signal 406 can be set at a value that is operable to open the switch 404, whereupon the power output 408 is disconnected from the voltage output from processor 400 which causes the charging signal 112 to stop. If the processor 400 decides that the charging signal 112 is to be continued (or re-started), the charge command signal 406 can be set at a value that is operable to close the switch 404, which means that power output 408 is connected to the voltage output from processor 400 so that charging signal 112 provides power to the electronic device 104.

The charger 102 also includes a current measuring circuit 402 that measures the current draw on power output 408. This measured current draw can be provided to an input for the processor 400 and serves as the monitored electrical characteristic of FIGS. 2A/2B. The processor 400 thus can make decisions about how to set the charge command signal 406 based on this measured current draw. FIG. 4B, which shows a schematic view of an example charger 102, includes an example of a current measuring circuit 402 that can be employed. For example, an inline current sense resistor can be used where the voltage drop across the current sense resistor is measured to support calculation of the current consumption by device 104. An amplifier circuit can be used to amplify the drop signal across the resistor so that the processor 400 can operate on a larger signal at the current measurement feedback input when computing the current draw. However, it should be understood that other current measurement techniques could be employed by circuit 402. For example, a MOSFET may be used in place of the current sense resistor. As another example, the current measurement circuit 402 could be a set trip point from a control integrated circuit (IC). Current measurement could also employ non-direct sensors such as Hall effect sensors, ferrite core/coil, etc.

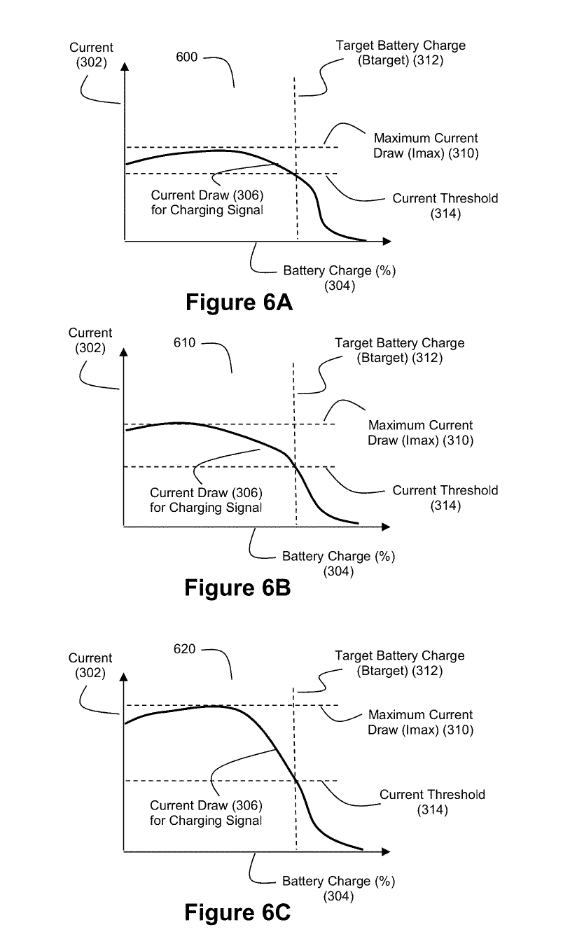

FIG. 5 depicts another example process flow for the charger that expands on the process flows of FIGS. 2A and 2B. At step 500, the charger's default state is ON (in which case switch 404 is closed and power is provided by the charging signal 112 to the electronic device 104). At step 502, the current drawn by the electronic device 104 is measured (see current measuring circuit 402 in FIGS. 4A and B). At step 504, this current measurement is fed into a decision-making algorithm executed by processor 400. As mentioned above, this algorithm can test whether the current draw measurement is above or below the current threshold 314. If the current draw is above the threshold, the processor can conclude at step 506 that the battery's charge state is relatively low and that the battery is not yet sufficiently charged (see step 508 and the process flow's return loop back to step 502). If the current draw is below the threshold, the processor can conclude at step 506 that the battery's charge state is relatively high and that the battery is sufficiently charged (see step 508 and the process flow's path to step 510). Steps 506-508 can define the threshold as the current threshold 314 or it can define the threshold as a percentage of the maximum current draw 310 that approximates the desired current threshold 314. To test for the former, the processor 400 can perform a direct comparison can be made between the measured current draw (e.g., as an instantaneous value or some average value over a sliding time window) can the current threshold 314. To test for the latter, the processor 400 can measure the maximum current draw for the battery charge cycle, and then test for when the measured current draw (e.g., as an instantaneous value or some average value over a sliding time window) falls below the measured maximum current by more than the defined percentage.

At step 510, the charger 102 stops the charging signal 112. To do so, the processor 400 can set the charge command signal 406 to a value that is effective to open switch 404, whereupon the power output 408 is disconnected from the voltage output from the processor 400.

When the processor 400 opens switch 404 as a result of steps 506-510, the processor 400 can also start a timer that defines a time period during which the charging signal 112 will remain off. The electronic device 104 may exhibit a relatively predictable discharge profile that allows for assumptions to be made about how that battery's charge may be depleted over time in response to usage when disconnected from charging power. Based on such a discharge profile, a practitioner can define the time period used by the timer (e.g., 30 minutes, although it should be understood that a wide range of values could be employed depending on factors such as the battery capacity of the electronic device, expected operational load on the battery, etc.). The discharge profiles of a device 104 may vary widely based on a number of factors. For example, for devices 104 that are expected to be connected in a manner that power will be consistently available if needed but where use will be relatively light, the discharge profile might be quite long (e.g., perhaps 8-10 hours for a timer duration before a re-charge is needed). But, for other devices 104 that may be periodically disconnected from an available source of external power for unpredictable durations (e.g., a tablet computer in a docking system, where the tablet computer may be undocked during use for extended durations), the discharge profile may be shorter to ensure that the device 104 will have sufficient charge to support extended use while external power is unavailable (e.g., perhaps a 30 minutes or 60 minutes for a timer duration before a re-charged is needed). Similarly, it may be desirable to set short timer durations for devices 104 that are expected to experience heavy usage. At step 512, the processor 400 checks whether the timer has expired. If not, the processor continues to wait for timer expiration. If the timer has expired, the process flow proceeds to step 514. At step 514, the charger turns the charging signal back on. This can be accomplished by setting the charge command signal 406 to a value that is effective to close switch 404.

Thus, it should be understood that FIG. 5 provides an example of a process flow for use by an intelligent charger 102 that is external to the electronic device 104 that uses the charging signal 112 to make inferences that estimate battery charge state and allows for selective control over charging signal 112 that is expected to better manage the health of the battery 106 on electronic device 104 and mitigate issues such as potential battery swelling.

As an enhancement to the operation of FIG. 5, the various settings used by the decision engine about turning the charging signal on/off (e.g., the threshold used for deciding when to turn the charging signal off and the time duration used for deciding when to turn the charging signal back on) can be designed as evolving settings that may vary by electronic device and/or over time.

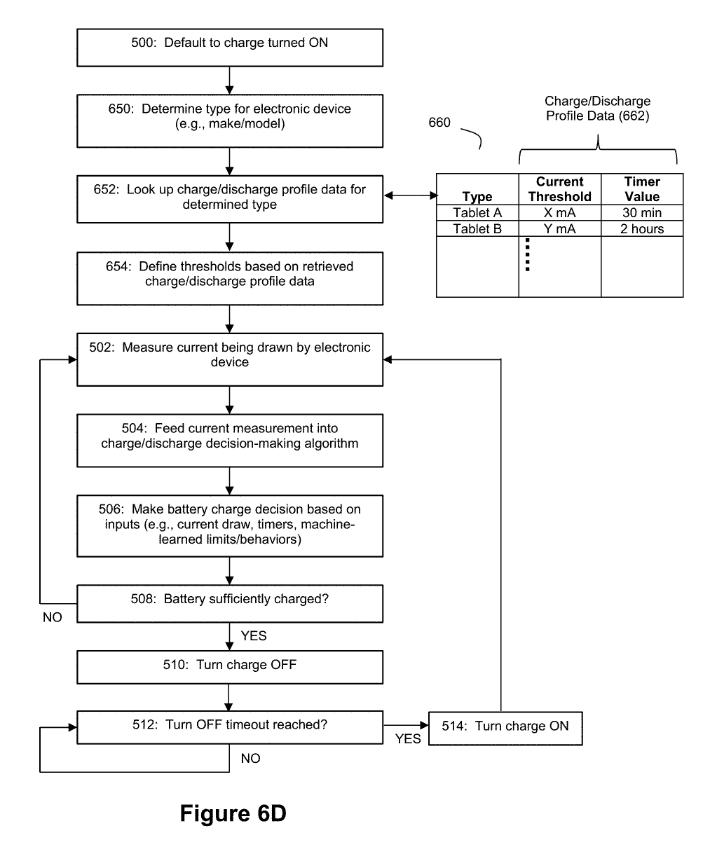

For example, different electronic devices 104 can be expected to exhibit different charging and discharging profiles, particularly different types of electronic devices. That is, for example, Make/Model A of a tablet computer from Manufacturer X may exhibit different charging and discharging profiles than Make/Model B of a tablet computer from Manufacturer Y. FIGS. 6A-C depict example plots that show how charging profiles 600, 610, and 620 respectively may differ for different types of electronic devices 104. As shown, each profile 600, 610, and 620 may exhibit different values for Imax 312, current threshold 314, and/or Btarget 312. To accommodate for such differences between different electronic devices, the intelligent charger 102 can be sufficiently flexible to adjust its control settings as a function of the type of electronic device to which it is connected.

FIG. 6D depicts an example process flow where the charger 102 adjust its control settings as a function of the type of electronic device to which it is connected. To support such operations, a memory that is accessible to processor 400 can store charge/discharge profile data 662 as function of device type. This memory can be local to the charger 102 or remote from the charger 102. In a remote example, a remote server could store charge/discharge profile data 662 for a wide variety of devices 104, the charger 102 can access this data on an as needed basis. In the example of FIG. 6D, table 660 stores different values for the current threshold and re-start timer in association with different types of electronic devices (e.g., Tablet A exhibits a current threshold of X mA and a timer duration of 30 min, while Tablet B exhibits a current threshold of Y mA and a timer duration of 45 min). At step 650 of FIG. 6D, the processor 400 can determine a type for the electronic device 104 to which the charger 102 is connected. For example, the processor can determine the make/model of the electronic device. Such type data can be made available to the processor 400 through interface 410; for example, through a USB interface connection with the electronic device 104, the device 104 can provide type data via one or more contact connections. For example, upon connection, a device 104 that is a USB device can output data that includes USB device descriptors. Device type can be determined from such descriptors. For example, the charger 102 can use base level descriptors that are broadcast in response to connection and also implement USB classes to query the device further e.g., USB image class, USB mass storage device class, etc.). At step 652, the processor looks up the appropriate charge/discharge profile data 662 for the determined device type from table 660. At step 654, the processor defines thresholds for steps 506-508 and 512 based on the retrieved charge/discharge profile data. In this manner, the operation of steps 502-514 can use control settings that are customized to particular types of electronic devices 104.

While the table 660 of FIG. 6D shows a relatively simple example where each device type is associated with a single current threshold value and a single timer threshold value, it should be understood that the table 600 could employ more support more complex adjustable settings if desired. For example, the discharge profile of an electronic device may vary based on a number of factors. As an example, time of day can have a significant impact on the discharge profile of the electronic device. In many commercial settings, the electronic device 104 will likely be unused after business hours (e.g., overnight). As such, for overnight periods, it can be expected that the electronic device 104 will not draw down the battery 106, in which case the charger 102 can allow the charging re-start time window to be relatively long. By contrast, during daytime hours, it may be the case that device usage will be more frequent, in which case battery discharge may occur in a shorter period of time, in which case it may be desirable for the charger 102 to employ a relatively shorter re-start time window. Thus, as an example, it should be understood that the discharge profile data may further define time durations for step 512 as a function of time of day (and with steps 652 and 654 further selecting and defining the timer values as a function of the current time of day). Further still, the age of the device 104 may impact discharge profiles as batteries and battery capacities may degrade over time. Customer usage patterns can also influence discharge profile data, where different discharge profile data may be used for different presumed categories of customer use (e.g., highly mobile use where external power may be unavailable for long durations; permanently mounted use where external power is expected to available as needed; high CPU use; high screen brightness use; etc.).

Further still, practitioners may analyze battery charging and discharging behaviors for electronic devices, and use this information to flexibly customize the values in table 660. For example, a practitioner may find that different shapes of charge profile curves as shown by FIGS. 3 and 6A-6C merit different timer values for the discharge profile. In such a case, the practitioner can select appropriate values to use for timer values in table 660 based on which timer values are deemed a good fit for the observed charge profile pattern of the subject electronic device 104.

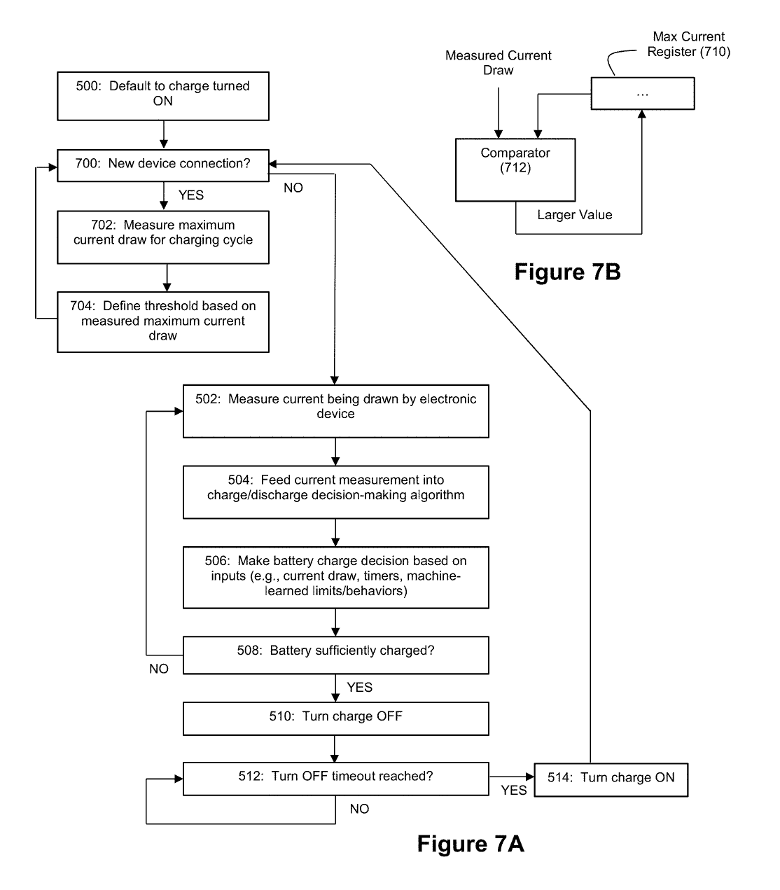

The control settings can also be learned by the charger 102. FIG. 7A depicts an example process flow where the charger 102 employs a learning protocol to define the current threshold used at steps 506-508. At step 700, the processor determines whether a new electronic device 104 has been connected to the charger 102. This new connection determination can be made each time an electronic device 104 has been connected to the charger 102 (regardless of whether that electronic device 104 has previously been connected to the charger 102), in which case the process flow proceeds from step 700 to step 702 each time a new connection is detected. However, in another example embodiment, step 700 can recognize an electronic device 104 that has previously been connected to the charger 102. To support this, the charger 102 can include a memory that stores a history of identifiers for electronic devices 104 that have previously been connected to the charger 102 (or least a past history up to some number of devices or for some past time window). Upon connection with an electronic device 104, the electronic device can provide data indicative of an identifier for the electronic device 104 (e.g., a serial number for a make/model or other suitable identifying information). The processor can track these identifiers in memory, and a new connection can be found if the identifier for the connected electronic device is not present in this connection history.

Upon finding a new connection, the process flow proceeds to step 702. At step 702, the charger 102 measures the current draw for the charging signal during the regular charging cycle of the electronic device up to full charge, and finds the maximum current draw for the charging cycle. FIG. 7B depicts an example of how step 704 can be carried out. The maximum current register 710 can store the running maximum current draw, and it can be initialized to zero at start up. The measured current draw can then be fed into comparator 712 for comparison with the running maximum value from register 710. Whichever of these two values is found to be larger by the comparator 712 can then be fed back into register 710 so that the register reflects the running maximum of the current draw. To prevent transient spikes in current from obscuring the registered maximum current draw, step 702 can also perform averaging on the measured current draw over a sliding window where this averaged current measurement is fed into the comparator 712.

At step 704, the processor 400 defines the current threshold 314 based on the measured maximum current draw. For example, the processor 400 may define the current threshold 314 as a specified percentage of the maximum current draw (e.g., 0.8*Imax). Thereafter, as the process flow proceeds through steps 502-514, the current threshold used at steps 506-508 can be the threshold learned via steps 700-704. Moreover, in an example embodiment where steps 700-704 are performed each time an electronic device 104 is connected to charger 102 (regardless of whether that device 104 had previously been connected to that charger), this learning process can create evolving current thresholds over time that adapt to changes in battery characteristics for a given electronic device over time. It may be the case that as an electronic device 104 ages, the assumptions made about its charge profile as reflected in FIGS. 3 and 6A-C no longer reflect the current state of the electronic device 104. The learning process of FIG. 7A thus allows the charger 102 to adapt its intelligent battery management operations for a given electronic device 104 over time.

FIG. 7C depicts another example process flow for learning and applying evolving limits with respect to controlling charging signal 112. In this example, it can be seen that the process flow includes a control step where it tests the duration of the (reduced) average current draw to prevent short transient drops in current from impacting the charging process. The amount of time used for this test can be chosen by a practitioner based on experience and needs. As shown by FIG. 7C, the trip points and other control settings can be adjusted based on action events and other periodic events. Accordingly, the control settings in the FIG. 7C workflow (such as the trip point below the DCML, the set amount of time that the average current resides below the trip point, the set amount of time that the charge is removed from the connected device 104, etc.) can all be very customized and dynamic depending on the device 104 that has been connected. These control setting values can be defined based on previous testing and characterization results or percentage-based values. In some cases, these control setting values may be predetermined and set, while others may be adaptable and dynamic, and for still others they may be directly manipulated in real time based on real-time information from the device 104 itself.

While FIGS. 2A-7C describe examples for intelligent battery management by charger 102 in an open loop situation where the charger 102 estimates the actual battery state, in other example embodiments the charger 102 can make charging decisions based on more of a closed loop determination of battery state. For example, if the interface between the charger 102 and electronic device 104 supports messaging from the electronic device 104 to the charger 102, then this communication channel can be used by the electronic device 104 to send information to the charger 102 for controlling the charging signal 112, which alleviates the charger 102 from making estimations of battery state based on electrical characteristics of the charging signal 112. Examples of a communication channel that can be used by an electronic device 104 with respect to a charger 102 located in a docking system are described in (1) U.S. provisional patent application 62/564,884, filed Sep. 28, 2017, and entitled “Docking System Unlock for Portable Computing Device”, (2) U.S. provisional patent application 62/594,344, filed Dec. 4, 2017, and entitled “Docking System for Portable Computing Device”, and (3) U.S. patent application Ser. No. 16/142,503, filed Sep. 26, 2018, and entitled “Docking System for Portable Computing Device” (published as US patent application Pub ______), the entire disclosures of each of which are incorporated herein by reference.

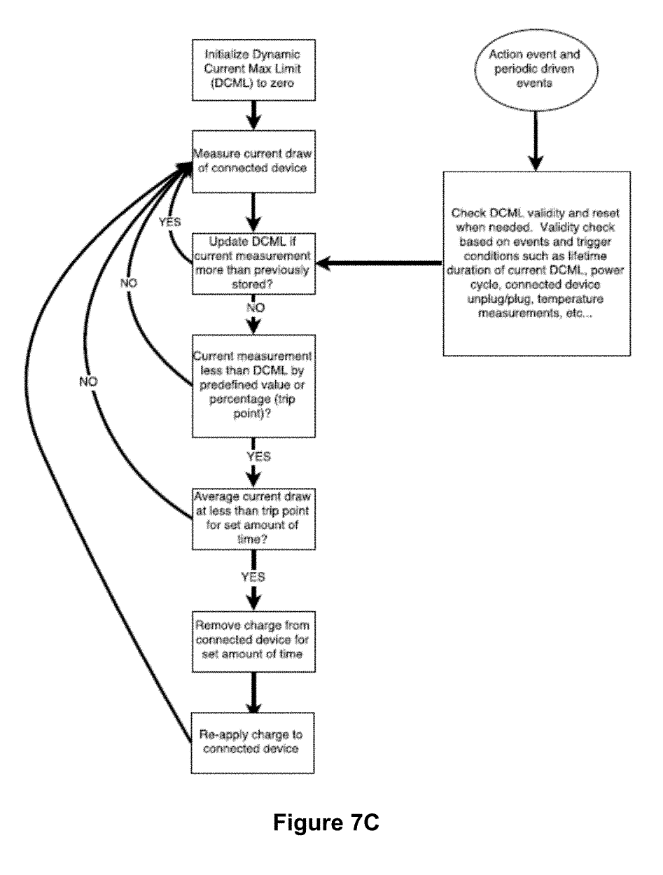

To support such operations, a software program such as an “app” can be deployed on the electronic device 104, and this software program can perform a process flow such as that shown by the example of FIG. 8A. The software program can be embodied by a plurality of instructions that are resident on a non-transitory computer-readable storage medium and are configured for execution by a processor. At step 800, the software on the electronic device 104 determines a characteristic of the battery 106. For example, the device 104 may maintain data values in various memory locations that reflect information such as the current charge state of the battery 106 (e.g., a charge percentage) and/or current battery temperature. At step 800, the software can read one or more of these data values to determine the battery characteristic. At step 802, the software can make a decision about whether the battery 106 needs further charging based on this determined battery characteristic. For example, the software may conclude that if the battery charge percentage exceeds a threshold value, then no charge is needed. The software may also conclude that if the battery charge percentage is below another threshold value, then charge is needed. Further still, the software may conclude that the charging signal 112 should be stopped if the battery temperature exceeds another threshold value (and regardless of the battery charge percentage state). As mentioned above, other factors could also be used by software 900 to support decision making about whether to charge (e.g., time of day). At step 802, the software can define a value for a charge command signal that reflects the decision about whether charging is needed. At step 804, this charge command signal can be provided to the charger 102 through the data channel interface between the electronic device 104 and charger 102.

FIG. 8B depicts a process flow for the charger 102 in relation to an electronic device that performs the process flow of FIG. 8A. At step 810, the charger 102 receives the charge command signal from the electronic device 104. At step 812, the charger 102 selectively controls the charging signal 112 based on the received charge command signal. Thus, if the received charge command signal corresponds to a command to reduce (e.g., stop) the charging signal 112, then the charger 102 can adjust the charging signal accordingly. If the received charge command signal corresponds to a command to increase (e.g., re-start) the charging signal 112, then the charger 102 can adjust the charging signal 112 accordingly.

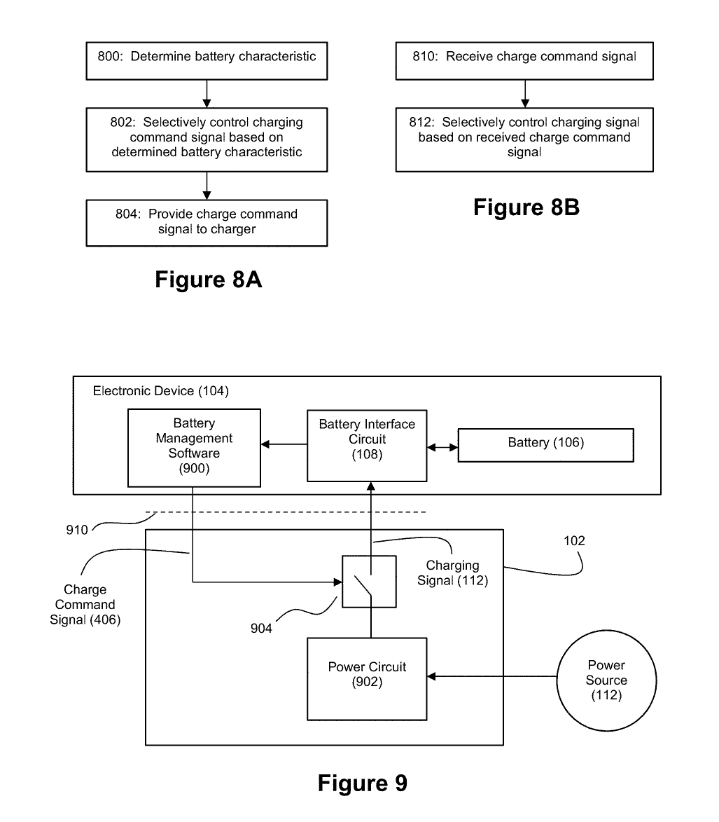

FIG. 9 depicts an example embodiment for the electronic device 104 and charger 102 with respect to the example process flows of FIGS. 8A and 8B. A processor and memory resident in the electronic device 104 can cooperate to execute battery management software 900, where execution of the battery management software 900 carries out the process flow of FIG. 8A. Battery management software 900 can be a third party application that is not an OEM application of the electronic device manufacturer. As an installed third party application, the software 900 may not have the requisite permissions to directly control how the battery 106 is charged from within the electronic device, but the software 900 can nevertheless leverage interface 910 to indirectly control how the battery is charged via communications with charger 102. Battery characteristic data (e.g., battery charge state and/or battery temperature) can be learned by the processor and stored in memory via battery interface circuit 108. The electronic device 104 can communicate the charge command signal 306 to charger 102 via a data channel within interface 910. As mentioned above, this interface between charger 102 and electronic device 104 can be a direct interface or an indirect interface. The charger 102 can include a power circuit 902 (e.g., a DC/DC voltage regulator that conditions input DC power from power source 112 to a DC voltage (e.g., 5V) for delivery to the electronic device 104 via charging signal 112. The charger 102 can also include a switch 904 (e.g., a FET switch or other suitable electronic switch) that is responsive to the charge command signal 306. A first value of the charge command signal 306 can close switch 904 so that the charging signal provides charge to the electronic device 104 through interface 910, and a second value of the charge command signal 306 can open switch 904 so that the charging signal 112 is stopped via a disconnection from power.

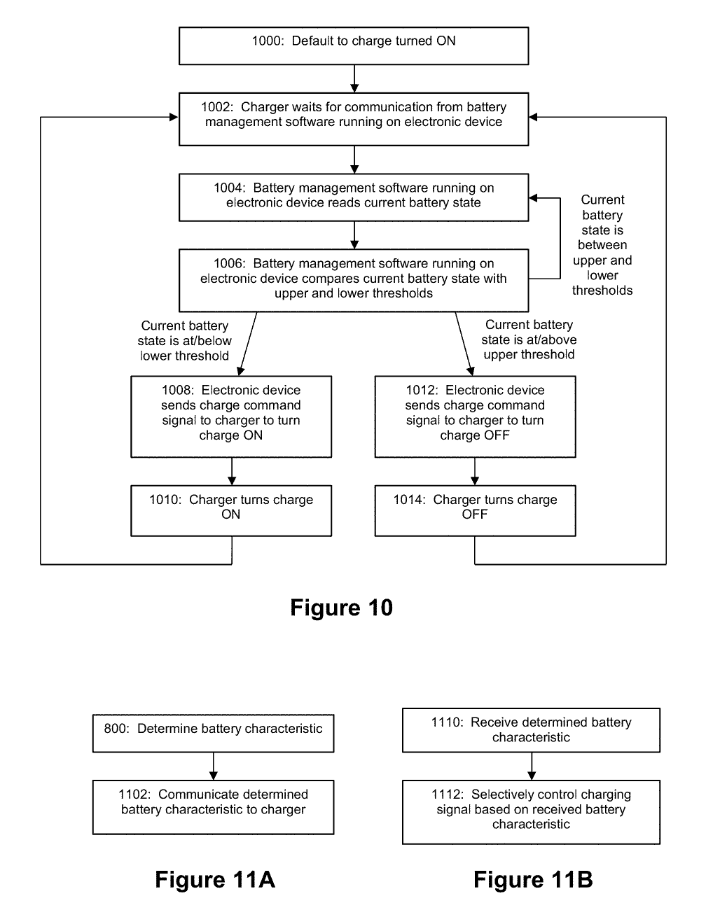

FIG. 10 depicts an example process flow for this example embodiment in greater detail. At step 1000, upon connection of the charger 102 with electronic device 104 as shown by FIG. 9, the charger 102 is defaulted for the charge to be turned ON (where switch 904 is closed). At step 1002, the charger 102 waits for communication from the battery management software 900 running on the electronic device 104. Meanwhile, the battery management software 900 reads the current battery state (step 1004). As mentioned, this information may already be stored by the electronic device 104, and step 1004 may involve simply accessing and reading the data.

Next, at step 1006, the battery management software 900 compares the current battery state with upper and lower thresholds. For example, the lower threshold can be a battery charge percentage of 25% and the upper threshold can be a battery charge state of 85% (although it should be understood that different values could be employed).

If step 1006 results in a decision that the current battery state is between the upper and lower thresholds, then the battery management software 900 can choose to maintain the current state of the charging signal (whether that current state be where the charging signal 112 is ON or OFF), and the process flow returns to step 1004.

If step 1006 results in a decision that the current battery state is at or below the lower threshold, then the battery management software 900 can choose set the charge command signal to a value that reflects a command to turn the charging signal ON. This charge command signal can then be communicated to the charger 102 via interface 910 (step 1008). At step 1010, the charger 102 receives this charge command signal and closes switch 904 in order to turn on the charging signal 112.

If step 1006 results in a decision that the current battery state is at or above the upper threshold, then the battery management software 900 can choose set the charge command signal to a value that reflects a command to turn the charging signal OFF. This charge command signal can then be communicated to the charger 102 via interface 910 (step 1012). At step 1014, the charger 102 receives this charge command signal and opens switch 904 in order to turn off the charging signal 112.

Thus, the example embodiments of FIGS. 8A-10 describe a closed loop technique where charger 102 is able to intelligently control the charging signal 112 in a manner to protect the health of battery 106.

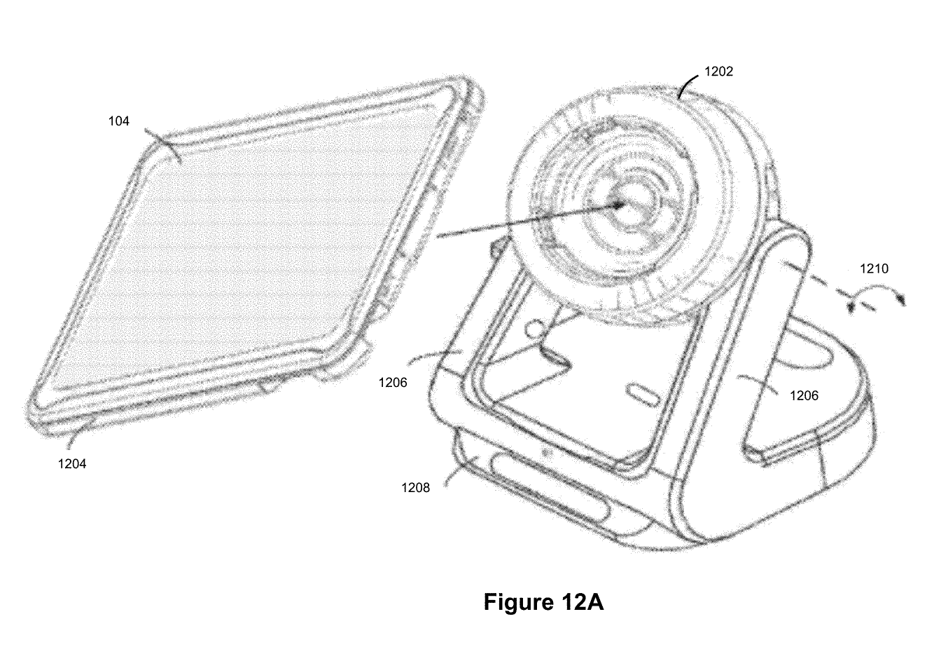

As another example of closed loop operation, the decision-making intelligence can be deployed in software or other logic on the charger 102 rather than in the battery management software 900 on the electronic device 104. An example embodiment of process flows for this is shown by FIG. 11A (which shows steps performed by the electronic device 104 and 11B (which shows steps performed by the charger 102). With such an example embodiment, the battery management software executed by a processor in the electronic device 104 can report battery characteristic data to the charger 102 through interface 910 rather than a charge command signal 406 (see step 1102 in FIG. 11A). The charger 102 would then receive the determined battery characteristic data (step 1110 in FIG. 11B) and selectively control the charging signal 112 based on the received battery characteristic data (see step 1112 in FIG. 11B). This selective control step can use the same decision-making logic as described for step 1006 in FIG. 10. In such an example embodiment, the charger 102 can have a configuration as shown for charger 102 of FIGS. 4A and/or 4B, but where the processor 400 receives battery characteristic data from the electronic device 104 and then sets the charge command signal 406 as a function of the received battery characteristic data. Further still, if the device 104 supports querying by an external device such as charger 102 to report out its battery characteristic data, the need for battery management software 900 that is aftermarket installed on the device 104 can be avoided. For example, some USB devices 104 support communications at the USB level using native capabilities of the device 104 to access and report on battery charge data. If the device 104 supports these types of communications, software 900 can be omitted, and the charger 102 can query the device 104 for battery characteristic data as needed.

The intelligent charger 102 as described herein with respect to examples such as FIGS. 4A, 4B, and 9 can take any of a number of forms. For example, circuitry for the charger 102 can be encapsulated in a power brick or the like, where such power brick includes (1) a first interface that is connectable to an input source of power, and (2) a second interface that is connectable to the electronic device 104 (either directly or indirectly).

As another example, circuitry for the charger 102 can be deployed on a circuit board or the like that is included in a docking system for an electronic device 104 such as a tablet computer. Examples of such a docking system is described in (1) U.S. provisional patent application 62/368,947, filed Jul. 29, 2016, and entitled “Docking System for Tablet Enclosure”, (2) U.S. patent application Ser. No. 15/659,556, filed Jul. 25, 2017, and entitled “Docking System for Portable Computing Device in an Enclosure”, published as US patent application Pub 2018/0032104, (3) U.S. provisional patent application 62/562,327, filed Sep. 22, 2017, and entitled “Base Assembly for Docking Station”, (4) U.S. provisional patent application 62/564,884, filed Sep. 28, 2017, and entitled “Docking System Unlock for Portable Computing Device”, (5) U.S. provisional patent application 62/594,344, filed Dec. 4, 2017, and entitled “Docking System for Portable Computing Device”, and (6) U.S. patent application Ser. No. 16/142,503, filed Sep. 26, 2018, and entitled “Docking System for Portable Computing Device” (published as US patent application Pub.

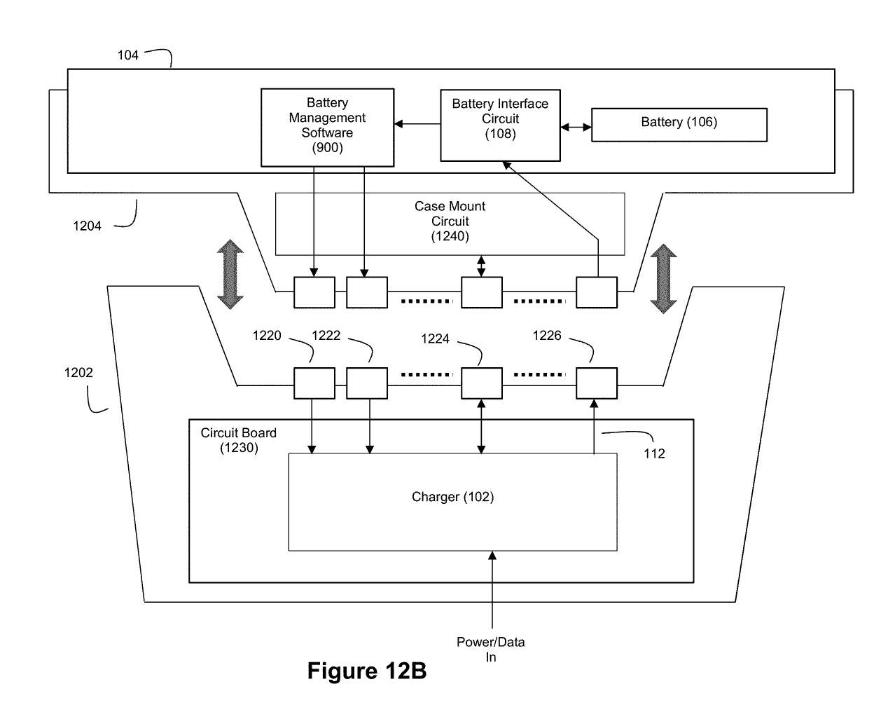

FIG. 12A shows an example of such a docking system, where the docking system includes a base mount 1202 that is adapted to receive and dock with a case enclosure 1204. The base mount can be connected to arms 1206 that extend from stand 1208. The arms can define an axis 1210 about which the base mount is rotatable. The case enclosure 1204 can enclose an electronic device 104 such as a tablet computer, and the case enclosure 1204 can be positioned to dock within a recess of the base mount 1202 and establish an electrical connection between circuitry in the base mount 1202 and case enclosure 1204. Through this electrical connection, charging power can be delivered to the electronic device 104. The charger 102 can be deployed as part of the circuitry in the base mount 1202 and/or case enclosure 1204.

FIG. 12B shows an example cross-sectional view of an example base mount 1202 and case enclosure 1204 where the intelligent charger 102 is deployed on a circuit board 1230 in the base mount 1202. The base mount 1202 can include a plurality of contacts that engage with complementary contacts of the case enclosure 1204 when the case enclosure 1204 is docked with the base mount 1202. These contacts can include data contacts 1220 and 1222 (where these contacts pass a data signal between the base mount 1202 and case enclosure 1204), a dock detect contact 1224 (which signals whether a docking with the case enclosure 1204 has occurred), and a power contact 1226 (through which the charging signal 112 is provided to the electronic device 104 by way of a circuitry in the case enclosure 1204 (e.g., a case mount circuit 1240). Thus, in response to detecting a dock event via dock detect contact 1224, the charger 112 can enable the charging signal 112 and initiate a process flow such as those shown in FIGS. 2A, 2B, 5, 6D, 7A, 8B, 10, and/or 11B. Moreover, if the charger 102 supports operation in the closed loop mode as discussed above, battery management software 900 can communicate a charge command signal and/or battery characteristic data to the charger 102 via data contacts 1220 and 1222 (and the charger 102 can selectively control the charging signal 112 accordingly as discussed herein).

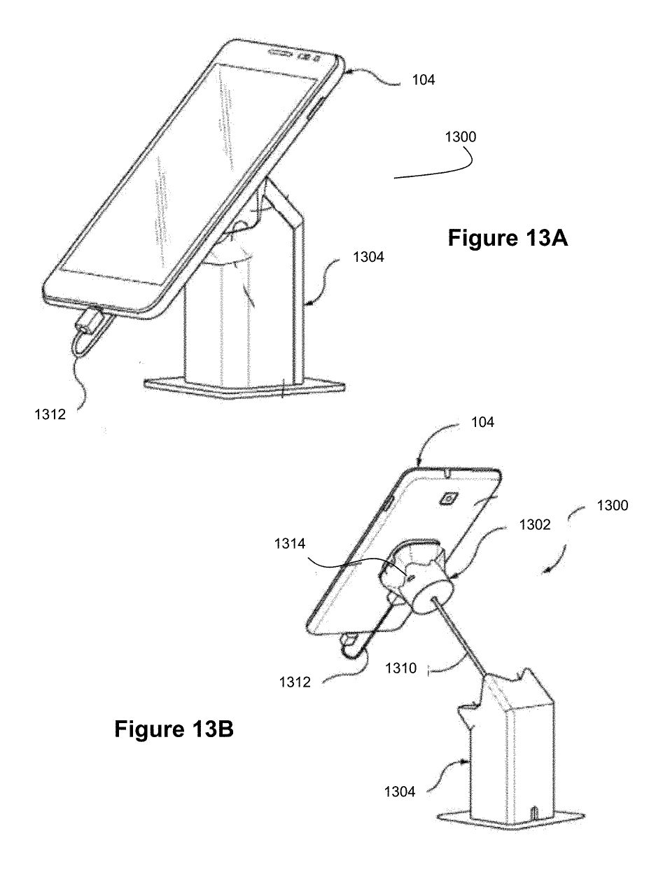

As yet another example, circuitry for the charger 102 can be deployed on a circuit board or the like that is included in a product display assembly for presenting the electronic device 104 to customers. Examples of product display assemblies 102 that can be adapted for use in the practice of the embodiments described herein are disclosed in U.S. Pat. Nos. 8,558,688, 8,698,617, 8,698,618, and 9,786,140; and U.S. Patent Application Publication Nos. 2014/0159898, 2017/0032636, 2017/0164314, and 2017/0300721, the entire disclosures of each of which are incorporated herein by reference. FIGS. 13A and 13B reproduce FIGS. 27 and 28 from the incorporated '140 patent and show an example product display assembly 1300 that is further described in the '140 patent. The product display assembly 1300 shown by FIGS. 13A and 13B includes a puck assembly 1302 and a base assembly 1304. The electronic device 104 can be mounted on and electrically connected to the puck assembly 1302, and the puck assembly 1302 can be moved between (1) a rest position where the puck assembly 1302 rests on the base assembly 1304 (see FIG. 13A) and (2) a lift position where the puck assembly 1302 does not rest on the base assembly 1304 (see FIG. 13B). The product display assembly 1300 may optionally include a tether assembly 1310 that keeps the puck assembly 1302 connected to the base assembly 1304 even when the puck assembly 1302 is in the lift position. A power cable 1312 provides an electrical connection between the puck assembly 1302 and an electronic device 104 for display through which the electronic device 104 can be charged. The puck assembly 1302 can receive power from a power source via the base assembly 1304 when the puck assembly is at rest. Electrical contacts included on the puck assembly 1302 and base assembly 1304 can contact each other when the puck assembly 1302 is at rest, thereby forming an electrical connection through which power can be delivered from a power source (not shown) to the puck assembly 1302 via the base assembly 1304 and the electrical connection formed by the contacts. When the puck assembly 1302 is lifted, the contacts lose contact with each other, thereby breaking the electrical connection. Charger 102 can be included as part of a circuit board that is present in the puck assembly 1302 or the base assembly 1304 if desired by a practitioner. This charger 102 can control whether a charging signal is provided to the electronic device 104 via cable 1312.

While the invention has been described above in relation to its example embodiments, various modifications may be made thereto that still fall within the invention's scope. Such modifications to the invention will be recognizable upon review of the teachings herein.

What is claimed is:

1. An apparatus for charging an electronic device that includes a battery, the apparatus comprising:
a circuit configured to produce a charging signal for charging the battery, wherein the circuit comprises a switch, and wherein the circuit is configured to selectively open and close the switch based on predefined criteria to thereby control the charging signal.

2. The apparatus of claim 1 wherein the circuit is further configured to open the switch in response a first predefined criterion being satisfied to thereby stop the charging signal.

3. The apparatus of claim 2 wherein the circuit is further configured to close the switch in response to a second predefined criterion being satisfied to thereby start the charging signal.

4. The apparatus of claim 1 wherein the circuit includes a cable through which the charging signal is provided to the electronic device for charging the battery.

5. The apparatus of claim 4 wherein the cable is detachably connectable to the electronic device.

6. The apparatus of claim 4 wherein the circuit is further configured to:
monitor a characteristic with respect to the cable; and
selectively control the switch based on the monitored characteristic as compared to the predefined criteria.

7. The apparatus of claim 6 wherein the characteristic comprises a current drawn by the electronic device through the cable.

8. The apparatus of claim 4 wherein the cable is configured to be detachably connectable to a smart phone.

9. The apparatus of claim 4 wherein the cable is configured to be detachably connectable to a tablet computer.

10. The apparatus of claim 1 wherein the circuit is part of a product display assembly for presenting the electronic device to customers.

11. An apparatus comprising:
a charger configured to connect with an electronic device for charging a battery of the electronic device, the charger comprising a circuit configured to:
monitor an electrical characteristic of a charging signal for delivery to the battery; and
selectively control the charging signal based on the monitored electrical characteristic.

12. The apparatus of claim 11 wherein the circuit is further configured to (1) compare the monitored electrical characteristic with a value, and (2) selectively control the charging signal based on the comparison.

13. The apparatus of claim 12 wherein the circuit is further configured to reduce the charging signal in response to the comparison resulting in a determination that the monitored electrical characteristic is less than the value.

14. The apparatus of claim 13 wherein the circuit is further configured to increase the charging signal based on a defined time after the charging signal was reduced.

15. The apparatus of claim 14 wherein the circuit comprises a switch, wherein the circuit is further configured to (1) open the switch in response to the comparison resulting in a determination that the monitored electrical characteristic is less than the value to thereby stop the charging signal, and (2) close the switch based on the defined time after the charging signal was stopped to thereby re-start the charging signal.

16. The apparatus of claim 11 wherein the circuit is further configured to (1) estimate a state for the battery based on the monitored electronic characteristic, and (2) selectively control the charging signal based on the estimated battery state.

17. The apparatus of claim 11 wherein the circuit is further configured to read a current drawn by the electronic device, wherein the drawn current serves as the monitored electronic characteristic.

18. An apparatus comprising:
a charger configured to connect with an electronic device, the charger comprising a circuit, wherein the circuit, in response to a connection of the charger with the electronic device, is configured to:
provide a charging signal to the electronic device to charge a battery of the electronic device;
receive a signal from the electronic device;
selectively control the charging signal based on the received signal; and
repeat the provide, receive, and selectively control operations over time while the charger is connected to the electronic device to actively manage how the battery is charged in response to changes in the received signal.

19. The apparatus of claim 18 wherein the received signal comprises a charge command signal.

20. The apparatus of claim 18 wherein the received signal comprises data that represents a characteristic of the battery.
